(19) United States
(12) Patent Application Publication
(10) Pub. No.: US 2011/0277619 A1
(43) Pub. Date: Nov. 17, 2011

(54) SYSTEMS, DEVICES AND METHODS FOR SHIP DEFENSE

(76) Inventor: Benjamin Blumenthal, Atlanta, GA (US)

(21) Appl. No.: 12/781,418

(22) Filed: May 17, 2010

(51) Int. Cl. F41H 11/00; B05B 17/00; A01K 3/00

(52) U.S. Cl. 89/1.11; 256/10; 239/289; 239/1

(57) ABSTRACT

The present invention includes systems for repelling a potential pirate boarding of a commercial ship. Electrification of metal surfaces around the sides of a commercial ship allows for providing an electric shock to a pirate attempting to scale a large commercial vessel from a small power boat. Additional systems allow for identification of breach site as well as site-specific responses including the firing of a water cannon to thwart pirate penetration.

### FIELD AND BACKGROUND OF THE INVENTION

The present invention relates to the field of ship defence in general and repelling of potential pirates in particular.

Hundreds of thousands of freighters ply the world's waters. Their cargo is measured in the trillions of dollars and is routinely shipped half-way across the world from manufacturer to consumer. Shipping still represents, by weight, the largest sector for moving materials ranging from oil to toys around the world.

Piracy is an ancient practice, one that first challenged the United States in its earliest years. To the shipping industry, pirates are not the colorful characters of stories or movies but rather terrorists bent on either ransom or theft. Protecting the world's ocean-transport fleet is an issue of saving lives and protecting billions of dollars worth of oil, raw materials, food, and finished products.

U.S. Pat. No. 2,223,533 to James teaches an electrical control apparatus for controlling the operating means of remotely located doors such as bulkhead doors and the like, comprising a multiple switch having a plurality of contacts arranged sequentially for connection with the respective door-operating means for closing circuits to the door-operating means to operate the same as the multiple switch is actuated; electric means for actuating said switch to close said contacts in sequence; a self-opening manual switch connected with said actuating means for controlling the excitation thereof to set said actuating means in operation by a momentary closure of said manual switch; and a further contact on said multiple switch connected to said actuating means for maintaining said actuating means in operation until closure of all said sequentially arranged contacts, the multiple switch in normal position closing no contacts but after actuation of said manual switch closing said further contact and then sequentially said door actuating contacts, said further contact being reopened before said door actuating contacts, which are then reopened by another actuation of said manual switch, said multiple switch being cyclic in nature and ready for another similar actuation when desired.

U.S. Pat. No. 3,949,212 to Larrimore describes an underwater light unit is constructed to be placed together within similar units around a ship anchorage on the bottom of a body of water. The construction of the optical portion of the housing permits the uniform illumination of said bottom with a high intensity light so as to produce good silhouette in the volume of water space located above the light units, as well as permitting direct observation of objects on said bottom. The optical portion and base portions fit together in such a manner as to have their watertight integrity remain unaffected by nearby explosions. The housing and mounting stake are constructed and arranged so as to provide a low mounting height above the bottom, so as not to interfere with the passage of surface vessels through the illuminated water space. A power distribution circuit connects each of the lighting units individually to a power source to permit individual service of the several units without interrupting the power flow to the remaining units or exposing the servicing personnel to unnecessary shock hazard.

US Patent Application Number US 2004/0113783 A1 to Yagesh teaches an invention is directed to a transportation security system for monitoring at least one freight shipping container being transported by at least one cargo transport vehicle. The system includes a container locking seal configured to be removably coupled to the at least one freight shipping container to thereby seal the at least one freight shipping container when in a coupled position. The container locking seal includes at least one anti-tamper sensor and a seal communications device. A state recorder is disposed in the at least one cargo transport vehicle. The state recorder includes a recorder communications system being configured to communicate with the seal communications device. The state recorder also includes a data storage module configured to store sensor data.

U.S. Pat. No. 6,765,487 to Holmes, et al describes a method and apparatus for detecting and deterring underwater threats is provided that uses numerous anodes and sensors around a ship or other waterborne structure to monitor for intruders and issue electrical shocks to the intruders in increasing amounts to deter sabotage. The underwater detection and deterrent system would provide an alarm and the approximate location of the intruder when the electrical field changes in response to the intruder. The system is capable of providing a lethal electrical shock to the intruder if necessary.

### SUMMARY OF THE INVENTION

It is therefore an object of the present invention to provide active repelling features against pirates attempting to board a ship. Specifically, some aspects of the present invention allow for electrifying portions of a ship and directing specific anti-pirate features towards intruders of a cargo ship or the like.

The invention includes a system for protecting a large ship from pirate boarding, including an onboard power plant; a plurality of predetermined metallic surfaces; and, electrical leads, wherein said electrical leads pass electricity from said power plant to said predetermined metallic surfaces, creating a high voltage across said surfaces.

In one aspect of the system, the metallic surfaces include the hull of the ship.

In another aspect of the system, the metallic surfaces include fences around the decks of the ship.

In another aspect of the system, the fences are placed on the outside hull of the ship.

In another aspect of the system, there are additionally water cannons and sensors for directing their fire.

In another aspect of the system, there are additionally alarms and flashing lights warning of an attempted penetration.

In another aspect of the system, there are additionally sensors for determining where on the metallic surfaces the pirate made contact.

The invention includes a method for automatically preventing a pirate attack against a vessel, including: providing a power-plant with the vessel; attaching electrodes between the power plant and predetermined exposed metallic surfaces on or around the vessel; running electricity through the metallic surfaces; and, allowing electricity to be delivered to a pirate upon the pirate's physical contact with the metallic surfaces.

In one aspect of the method, the vessel includes a desalination facility.

In another aspect of the method, the vessel is a container vessel.

In another aspect of the method, the pirate reaches the vessel from a small motor boat.

In another aspect of the method, there is additionally the step of determining the location of the pirate so as to either capture or repel him.

In another aspect of the method, there is additionally the step of spraying water from a water cannon on the pirate.

In another aspect of the method, the water cannon is capable of firing concentrated brine at the pirate.

In another aspect of the method, the electricity is passed to said metallic surfaces for predetermined periods of time.

In another aspect of the method, the electricity is at a predetermined voltage and current, wherein the current is high enough to incapacitate said pirate.

In another aspect of the method, there is additionally the step of providing a multilingual warning when something contacts a portion of the metallic surfaces.

In another aspect of the method, the multilingual warning includes a warning not to attempt entry to said vessel.

The invention additionally includes a system for repelling at least one pirate from a vessel, including an electrified fence around the vessel, sensors for determining location of attempted pirate penetration, and water cannons responsive to the sensors for directing high-intensity water spray at the location of attempted pirate penetration.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 shows a schematic view of an electrical ship protection system;

FIG. 2 shows a schematic view of an electrical ship protection system from a different angle;

FIG. 3 shows a schematic view of an alternative embodiment of an electrical ship protection system;

FIG. 4 shows a schematic view of an embodiment of an electrical ship protection system with additional warning elements;

FIG. 5 shows a schematic view of an embodiment of an electrical ship protection system including water canons; and,

FIG. 6 shows a flowchart for a method associated with the present invention.

### DETAILED DESCRIPTION OF EMBODIMENTS

### Description of the Preferred Embodiment

In the following description, numerous specific details are set forth in order to provide a thorough understanding of the present invention. It will be apparent, however, to one skilled in the art that the present invention may be practiced without these specific details. In other instances, well-known circuits and control logic have not been shown in detail in order not to unnecessarily obscure the present invention. The following definitions are for aiding in understanding the present invention.

### DEFINITIONS

Certain terms are now defined in order to facilitate better understanding of the present invention.

Many terms will have their generally accepted meanings within the context of the present invention. Terms not specifically defined otherwise may have their generally accepted meaning.

“Vessel” or “large ship” may generally refer to water-going ships with displacements of 150,000 metric tons or more. While the present invention may have applicability to ships and boats of all sizes, a purpose of the present invention is to protect valuable cargo and crew carried by large transport ships plying international waters.

“Pirate” may generally refer to an individual who attempts to enter a vessel illegally with the intent of hijacking the ship and/or stealing a portion of its contents. Pirates may have economic or political goals in hijacking a ship.

“Water cannon” may refer to an element that can fire water or other liquids at a high velocity at a predetermined target or location. Sensors may be employed to determine the direction of water cannon fire.

“Metallic surface” may refer to a metallic or otherwise conducting surface. The metallic surface may be an integral part of a ship or vessel, or it may be an added element for the purposes of executing an embodiment of the present invention. The anchor and other conductive surfaces may play the role of “metallic surface” for the present invention.

Electrical circuits may include resistors, meters, transformers, capacitors and other elements that may not be shown in the figures.

Off of the eastern coast of Africa and in major shipping lanes, piracy remains commonplace. From Saudi oil tankers to giant Russian freighters carrying tanks, dozens of ships have been hijacked by “Somali pirates” and others. The perpetrators generally seek ransom for return of the ship and crew and in many cases ransoms have been paid by either governments or private firms. In at least one case, US Navy personnel saved the captain of a US freighter when he was taken captive by Somali pirates. The captain was freed when several pirates were killed by Navy marksmen.

The present invention includes a combination of elements to repulse a pirate boarding. Whereas in the days of yore when equally-sized vessels would approach and pirates would jump from ship to ship, modern-day pirates generally use small craft to approach and then scale the larger, target vessel. Disrupting the act of scaling from small (often inflatable) motorboats to a larger craft is a focus of the present invention.

### First Embodiment

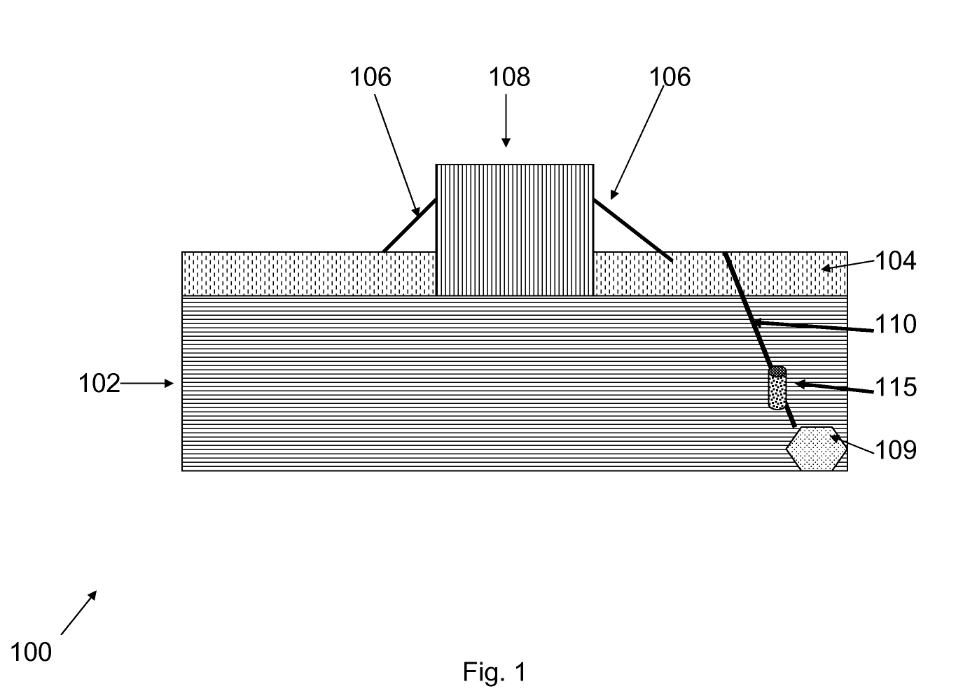

Attention is turned to FIG. 1, which shows a schematic embodiment of an anti-pirate protection system 100. A vessel 102 (side view) includes a metal surface 104 that can receive electrodes 106 from a power plant 108. The elements shown here are shown for ease of understanding the invention but they may be part of other elements or not be readily visible. The electrodes 106 may include resistors, capacitors, meters, insulators, and other electrical elements needed for an appropriate electrical circuit. The vessel 102 may be of any size, though the invention is especially appropriate for oil tankers, freighters and luxury yachts, as they are often the most valuable targets of modern-day pirates.

As shown in FIG. 1, a pirate boat 109 is located in proximity to vessel 102. A scaling line 110 is sent from the pirate boat 109 to the decks of the vessel 102. Pirates could alternatively use ladders, ropes or other features to penetrate the vessel 102. Under normal circumstances, one or a plurality of pirates 115 would scale the scaling line 110 in order to enter the vessel 102, overpower the crew (not shown) and take effective control of the vessel 102 and its contents (not shown). In the present invention, power plant 108 creates a voltage across the metal surface 104 with the aid of electrodes 106. The voltage may generally be in the kilovolt to megavolt range, with a current in micro- to milliamperes. Such a condition in the metal surface 104 would lead to a severe electrical shock for any pirate 115 attempting to scale the vessel 102 and commandeer the ship. The power applied across the metal surface would be great enough to allow for shocking of pirate 115, even if the latter came with gloves on his hands. The goal is to stun the pirate 115 and cause him to fall back to the sea (not shown). The voltage can be regulated; however, it would not generally be set high enough to cause death.

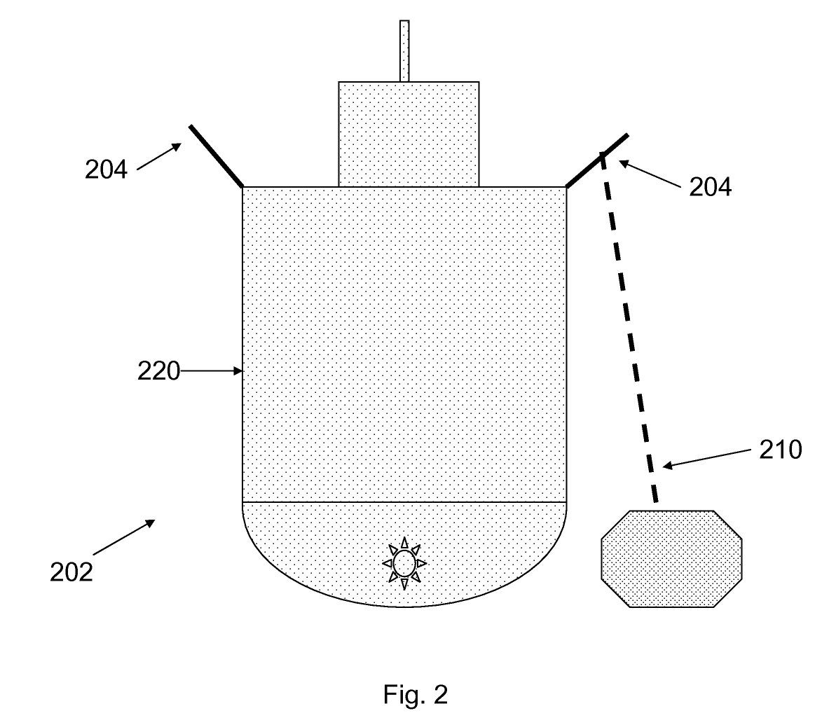

Attention is now turned to FIG. 2, which shows the same vessel 202 from a rear view. The metallic surface 204 is shown at an angle relative to the side 220 of the vessel 202. This arrangement has several advantages. Firstly, it reduces the risk of crew contact with metallic surface 204 and thus allows metallic surface to be continuously actively charged. This feature is important, as one does not know at which hour pirates may strike. Additionally, the angle of the metallic surface 204 makes boarding of the vessel 202 by a pirate more challenging. Additionally, a scaling line 210 would not rest on the side 220 of the vessel 202, due to the angle of the outward metallic surface 204 away from the vessel 202. The metallic surface 204 does not have to be at a non-zero angle relative to the side 220 of the vessel 202, but such an arrangement does provide higher crew safety and make scaling of the vessel 202 side 220 more difficult—independent of the issue of electric charging of the metallic surface 204. No metallic surface is shown in the back of the vessel 202 in FIG. 2 for ease of viewing of the figure.

### Second Embodiment

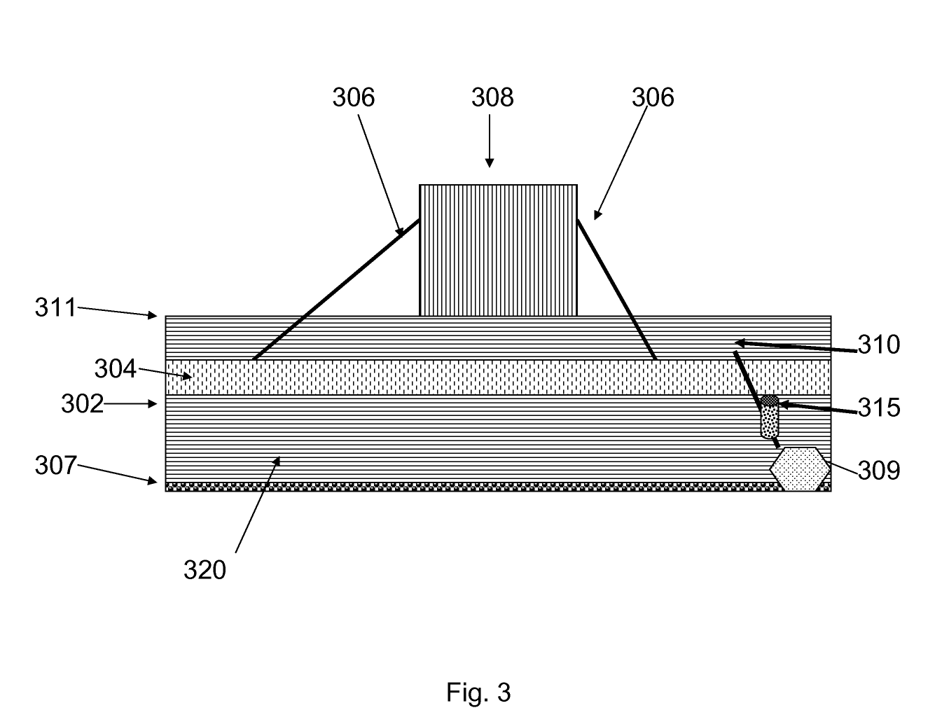

Attention is now turned to FIG. 3 which shows an alternative embodiment of the present invention. Similar elements are advanced by 200 from their corresponding elements in FIG. 1. A vessel 302 includes a metallic surface 304 attached to electrodes 306 in electric communication with a power plant 308. The power plant 308 may be any element capable of producing electricity—it may be part of the vessel's propulsion system, may be used for desalination or other industrial processes or it may be dedicated for charging the metallic surface 304. The metallic surface 304 is located along the side 320 of vessel 302, far away from the deck 311, where it may endanger crew, but high enough above the water line 307 to impede a pirate 315 from attempting to gain entry to the vessel 302. The metallic surface 304 can be a part of the hull of the vessel 302, the whole hull or a separate element placed somewhere between the water line 307 and the deck 311. The metallic surface 304 can also be integrated into the vessel's anchor (not shown) and attaching anchor chain (not shown). If the metallic surface 304 is present at a non-zero angle (generally 45 degrees, though one cannot see as such in this side view), then pirate 315 would be hard-pressed to get his scaling line 310 beyond the metal surface 304. He would not have easy access to the deck 311.

### Third Embodiment

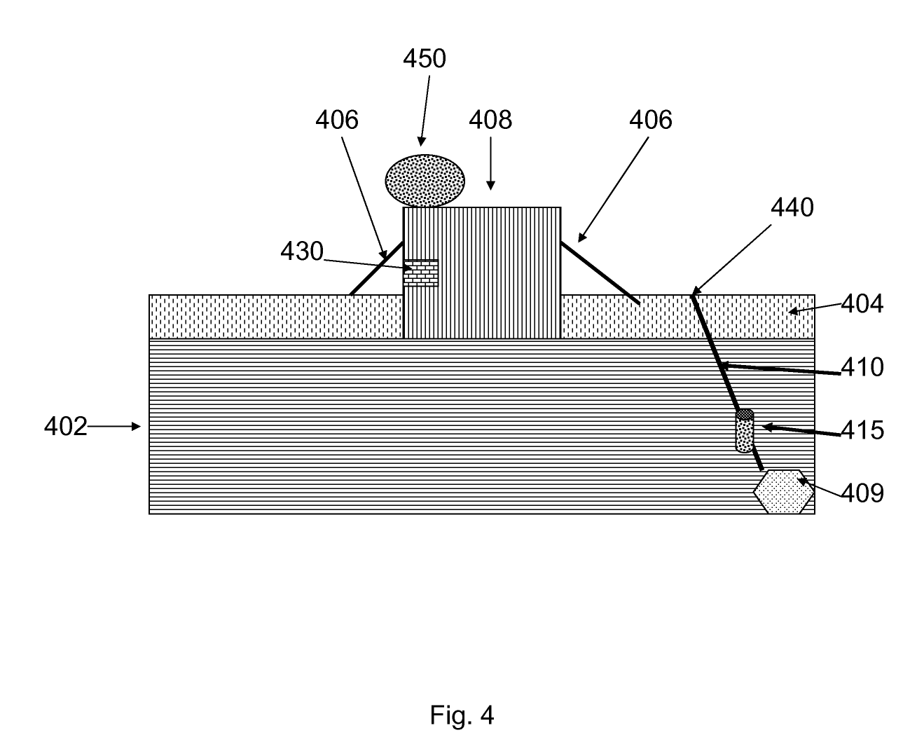

Attention is turned to FIG. 4 which shows an alternative embodiment of the invention. Vessel 402 includes a metallic surface 404 that is electrically charged by power plant 408 through electrodes 406. The vessel 402 additionally includes a sensor 430 that can detect attempted penetration location 440. There is additionally at least one loud-speaker 450 to broadcast in multilingual format a warning to leave the vessel 402 immediately. The sensor 430 can detect attempted penetration location 440 by any means, including but not limited to optical, electrical, motion sensors, or change in a physical property of the metallic surface. Pirate 415 attempt to scale vessel 402 from a power boat 409 through the agency of a scaling line 410 causes sensor 430 to detect attempted penetration location 440 and thus raise the alarm, which may includes lights, sounds, and warning broadcast through the loud-speaker 450 or a plurality of loud-speakers (not shown).

### Fourth Embodiment

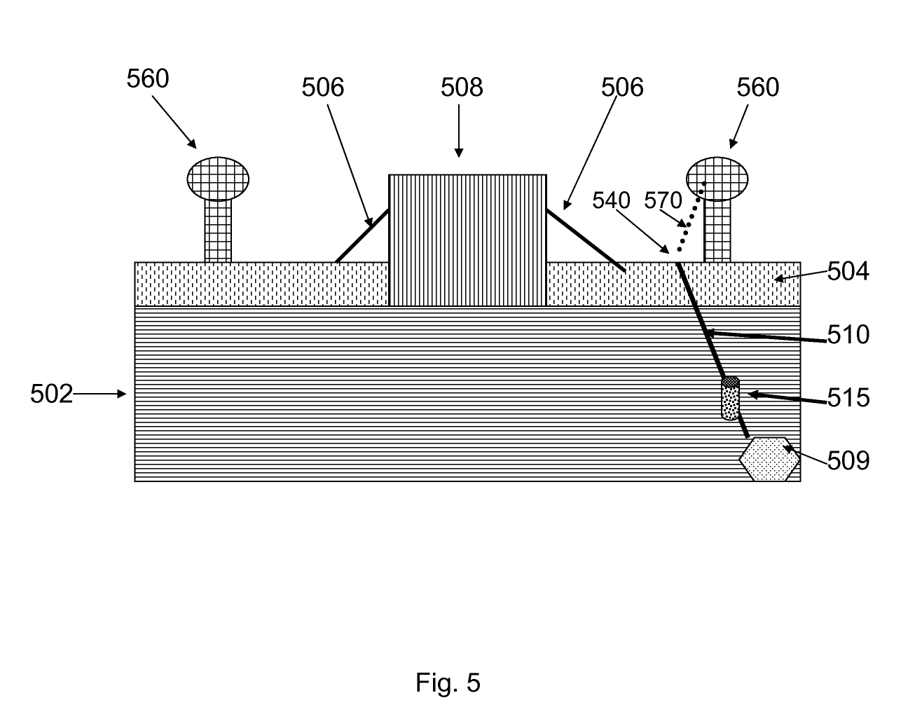

Attention is now turned to FIG. 5, which shows an embodiment of the invention. Vessel 502 includes a plurality of metallic surfaces 504 that are charged via a power plant 508 and appropriate high-voltage electrodes 506. Water cannons 560 are placed on the vessel 502, generally on the deck, and are capable of spraying water 570, brine, or other fluids at a penetration location 540 or thereabouts where a pirate 515 attempts to board vessel 502 from his power boat 509, via a scaling line 510. The water cannons 560 provide two advantages. Firstly, they spray water 570 or other fluid at high intensity to dislodge a pirate 515, and they additionally make the charged metallic surfaces 502 more dangerous for a potential intruder. It is understood that water cannons 560, loud-speakers (see 450 in FIG. 4), sensors, motion detectors, low-light binoculars, CC cameras, and other elements may be used in combination with additional embodiments of the present invention.

### Fifth Embodiment

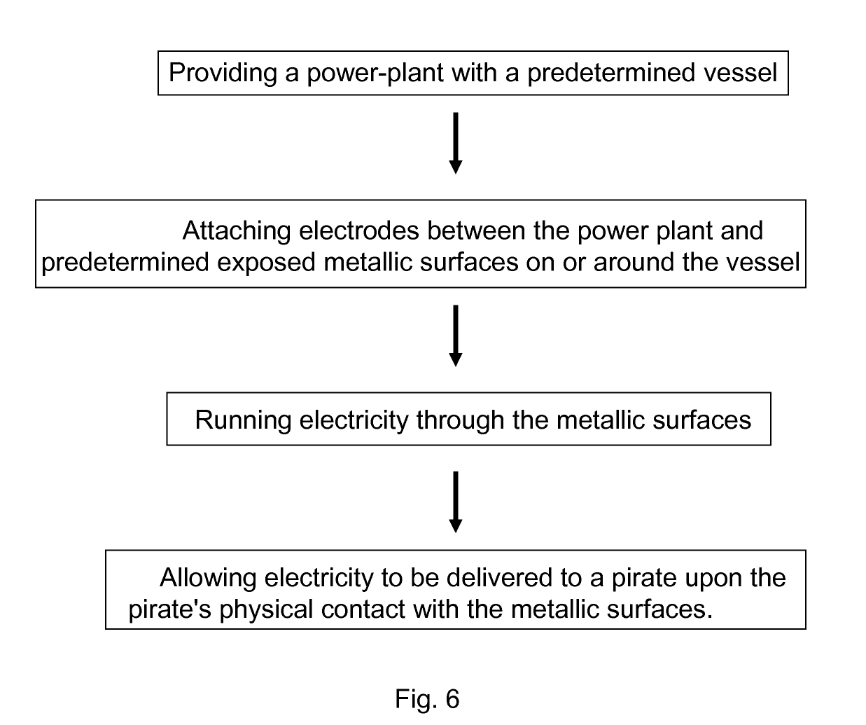

Attention is turned to FIG. 6 which shows a method for automatically preventing a pirate attack against a vessel, including: providing a power-plant with the vessel; attaching electrodes between the power plant and predetermined exposed metallic surfaces on or around the vessel; running electricity through the metallic surfaces; and, allowing electricity to be delivered to a pirate upon the pirate's physical contact with the metallic surfaces. The method obviously could include additional responses, as described above as well as manual responses such as shooting by security to personnel and/or contact to naval or police vessels of the attempted breach.

### Some Benefits of the Use of the Present Invention

The usefulness of the present system is typically evident in the following ways:
a) The electrification of an external portion of a vessel allows for 24/7 protection of a ship, without active intervention of crew.
b) The electric shock provided to a pirate or a plurality of pirates at multiple locations gives an electric signal to both crew and additional defense systems as to the location of a potential breach.
c) The systems allow for the protection of valuable cargo that travels in high-risk sea lanes, such as those to the east of the African coast.
d) The various response systems—electrified surface, water cannons, loud speakers, cameras, etc. can all be integrated to give a powerful response to repel potential pirate attacks on a commercial ship.

It will be appreciated by persons skilled in the art that the present invention is not limited to what has been particularly shown and described hereinabove. Rather, the scope of the present invention is defined by the appended claims and includes both combinations and sub-combinations of the various features described hereinabove as well as variations and modifications thereof which would occur to persons skilled in the art upon reading the foregoing description. Accordingly, it is intended to embrace all such alternatives, modifications and variations that fall within the scope of the appended claims.

1. A system for protecting a large ship from pirate boarding, including:
an onboard power plant;
a plurality of predetermined metallic surfaces; and,
electrical leads, wherein said electrical leads pass electricity from said power plant to said predetermined metallic surfaces, creating a high voltage across said surfaces.

2. The system according to claim 1, wherein said metallic surfaces include the hull of said ship.

3. The system according to claim 1, wherein said metallic surfaces include fences around the decks of said ship.

4. The system according to claim 3, wherein said fences are placed on the outside hull of said ship.

5. The system according to claim 1, further including water cannons and sensors for directing their fire.

6. The system according to claim 1, further including alarms and flashing lights.

7. The system according to claim 1, further including sensors for determining where on said metallic surfaces said pirate made contact.

8. A method for automatically preventing a pirate attack against a vessel, including:
providing a power-plant with said vessel;
attaching electrodes between said power plant and predetermined exposed metallic surfaces on or around said vessel;
running electricity through said metallic surfaces; and,
allowing electricity to be delivered to a pirate upon said pirate's physical contact with said metallic surfaces.

9. The method according to claim 8, wherein said vessel includes a desalination facility.

10. The method according to claim 8, wherein said vessel is a container vessel.

11. The method according to claim 8, wherein said pirate reaches the vessel from a small motor boat.

12. The method according to claim 8, further including the step of determining the location of said pirate so as to either capture or repel him.

13. The method according to claim 12, further including the step of spraying water from a water cannon on said pirate.

14. The method according to claim 13, wherein said water cannon is capable of firing concentrated brine at said pirate.

15. The method according to claim 8, wherein said electricity is passed to said metallic surfaces for predetermined periods of time.

16. The method according to claim 8, wherein said electricity is at a predetermined voltage and current, wherein said current is enough to incapacitate said pirate.

17. The method according to claim 8, further including the step of providing a multilingual warning when something contacts a portion of said metallic surfaces.

18. The method according to claim 17, wherein said multilingual warning includes a warning not to attempt entry to said vessel.

19. The system according to claim 5, further including sensors to direct said water cannons.

20. A system for repelling at least one pirate from a vessel, including an electrified fence around said vessel, sensors for determining location of attempted pirate penetration, and water cannons responsive to said sensor for directing high-intensity to water spray at said location.
